(19) United States
(12) Patent Application Publication
(10) Pub. No.: US 2026/0080556 A1
(43) Pub. Date: Mar. 19, 2026

(54) CALIBRATION OF ENSEMBLE OF LOCALIZATION MODELS CONFIGURED TO DETERMINE POSE OF IMAGE FRAME

(71) Applicant: Niantic Spatial, Inc., San Francisco, CA (US)

(72) Inventors: Eric Brachmann, Hanover (DE); Tommaso Cavallari, Oxford (GB); Victor Adrian Prisacariu, Oxford (GB)

(21) Appl. No.: 18/887,207

(22) Filed: Sep. 17, 2024

(51) Int. Cl. G06T 7/70; G06T 15/00; G06T 19/00

(52) U.S. Cl. CPC G06T 7/70; G06T 15/00; G06T 19/006

(57) ABSTRACT

A system performs image-based localization with an ensemble of localizers. The system receives a target frame from image data captured by a camera assembly of a client device. The system deploys an ensemble of localizers, each disparately trained to output a pose of the target frame and a model-specific confidence for the pose. The system calibrates each model-specific confidence by applying a model-specific calibration transformation to transform the model-specific confidence to a calibrated confidence. The system determines a final pose for the target frame by aggregating the poses output by the ensemble based on the calibrated confidences. The system may provide a visual positioning service (VPS) with the image-based localization. The system may also leverage the image-based localization to generate augmented reality content for presentation to a user.

### BACKGROUND

The application relates to the technical field of computer vision.

In modern digital infrastructures, image-based localization—a computational endeavor to take an image of an environment and to estimate the observer's position and orientation within that environment—is a cornerstone tool. However, the success of image-based localization is often hindered by the complexities in the uniqueness of each image, variations in the lighting, presence or absence of certain features from frame to frame, ability to handle imaging artifacts, differing scales between different camera assemblies, or some combination of the above all present challenges to providing consistently accurate localization. Accordingly, leveraging a single localization model (also referred to as a “localizer”) can be advantageous in certain situations, while being ill-equipped for other scenarios. There is not a one size fits all approach that delivers consistently good results.

Furthermore, it is challenging to arrange and coordinate multiple localizers. To produce a coherent pose, i.e. position and orientation in a three-dimensional space, from multiple localizers, the system must be able to compare outputs by the disparate localizers. But direct comparability is often infeasible as each localizer may be configured to output confidences in differing numerical ranges or according to different behaviors. This creates a technical problem in trying to harmonize the predictions from the localizers into a singular, accurate pose prediction.

### SUMMARY

A system performs image-based localization with an ensemble of calibrated localizers. The system may provide a visual positioning service (VPS) with the image-based localization. The system may also leverage the image-based localization to generate augmented reality content for presentation to a user.

To calibrate the localizers, the system leverages a calibration data set including image data and corresponding ground truth pose data. To calibrate one localizer, the system inputs the calibration data set into the localizer to output poses and model-specific confidences. The system can determine a calibration transformation to conform the model-specific confidences to a standard curve.

During deployment of the ensemble, the system receives a target frame from image data captured by a camera assembly of a client device. The system deploys an ensemble of localizers, each disparately trained to output a pose of the target frame and a model-specific confidence for the pose. The system calibrates each model-specific confidence by applying a model-specific calibration transformation to transform the model-specific confidence to a calibrated confidence. The system determines a final pose for the target frame by aggregating the poses output by the ensemble based on the calibrated confidences.

The calibrated ensemble of localizers provides for a technological solution to the challenges described above. For one, leveraging an ensemble exploits the strengths of each localizer, while avoiding the weaknesses of each. Moreover, the ensemble can provide a more accurate and precise output compared to the individual localizers. For two, calibrating the ensemble provides for comparability of outputs across the localizers, empowering the ensemble to output coherent and harmonized outputs.

### BRIEF DESCRIPTION OF THE DRAWINGS

FIG. 1 depicts a representation of a virtual world having a geography that parallels the real world, according to one or more embodiments.

FIG. 2 depicts an exemplary interface of a parallel reality game, according to one or more embodiments.

FIG. 3 is a block diagram of a networked computing environment suitable for image-based localization with an ensemble of calibrated localization models, according to one or more embodiments.

FIG. 4 is a flowchart illustrating localization model calibration, according to one or more embodiments.

FIG. 5 is a flowchart illustrating deploying of an ensemble of calibrated localization models, according to one or more embodiments.

FIG. 6 is a flowchart describing deployment of an ensemble of calibrated localization models, according to one or more embodiments.

FIG. 7 is a flowchart describing calibration of an ensemble of calibrated localization models, according to one or more embodiments.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where VPS-based pose verification is desirable. In addition, the inherent flexibility of computer-based systems allows for a great variety of possible configurations, combinations, and divisions of tasks and functionality between and among the components of the system.

Various embodiments relate to the context of a visual positioning service (VPS). A VPS determines the precise location of a user or device by analyzing visual data captured from the device's camera assembly. A localization model compares a target frame against a database of reference images or maps to predict the device's position and orientation in real-time. VPS technology offers enhanced location accuracy and context awareness compared to traditional global positioning system (GPS) reliant systems, particularly in indoor and urban environments where GPS signals may be weak or unavailable.

### Example Location-Based Parallel Reality Game

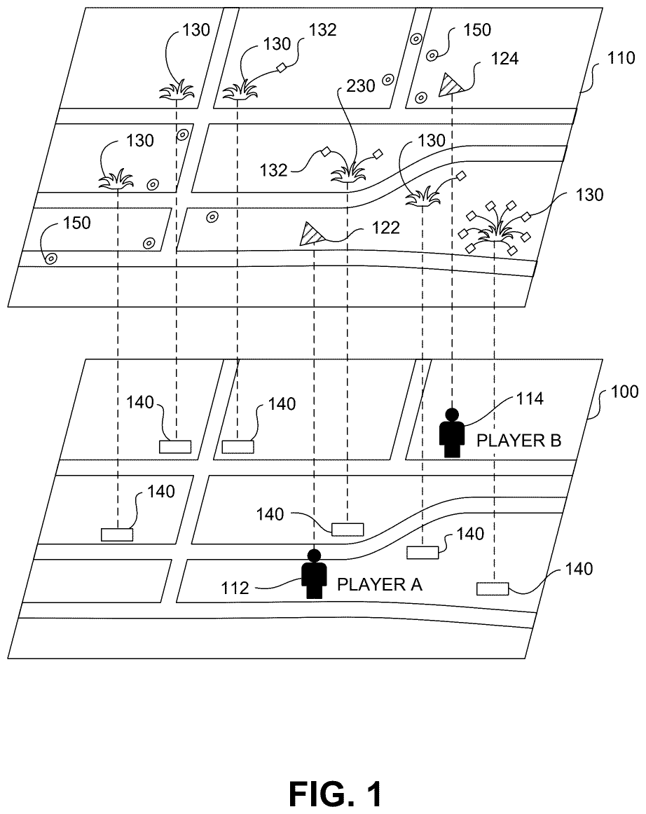

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

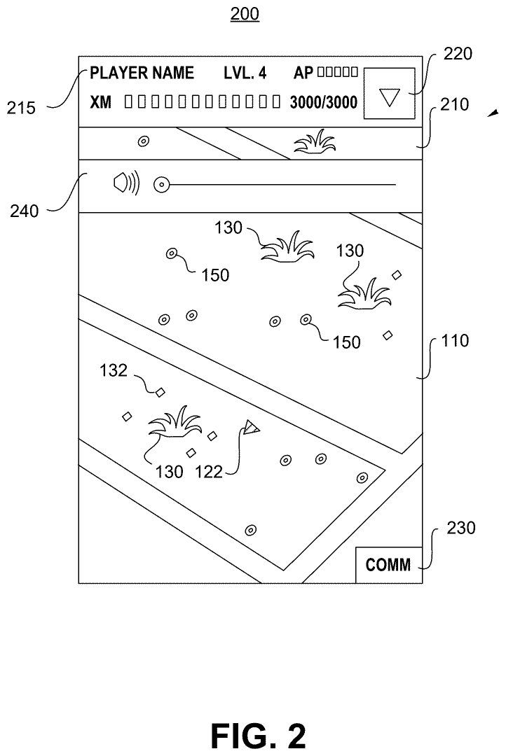

FIG. 2 depicts one or more embodiments of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a mobile device (e.g., a smart phone) and moving about in the real world with the mobile device. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

To generate the visual representation, a game server can generate and maintain a virtual map, e.g., that corresponds to the real-world environment. To generate the virtual map, the game server may collect image data from mobile devices of the physical environment. With the image data, the game server can create digital spatial models describing the physical environment. For example, the game server may leverage volumetric scene reconstruction algorithms to generate the spatial models from the image data (or pose data). In other embodiments, when generating virtual elements in an augmented reality context, the game server may perform localization to identify a pose of the mobile device. With the pose in hand, the game server can accurately identify positions to generate the virtual elements to augment the image data captured by the mobile device.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

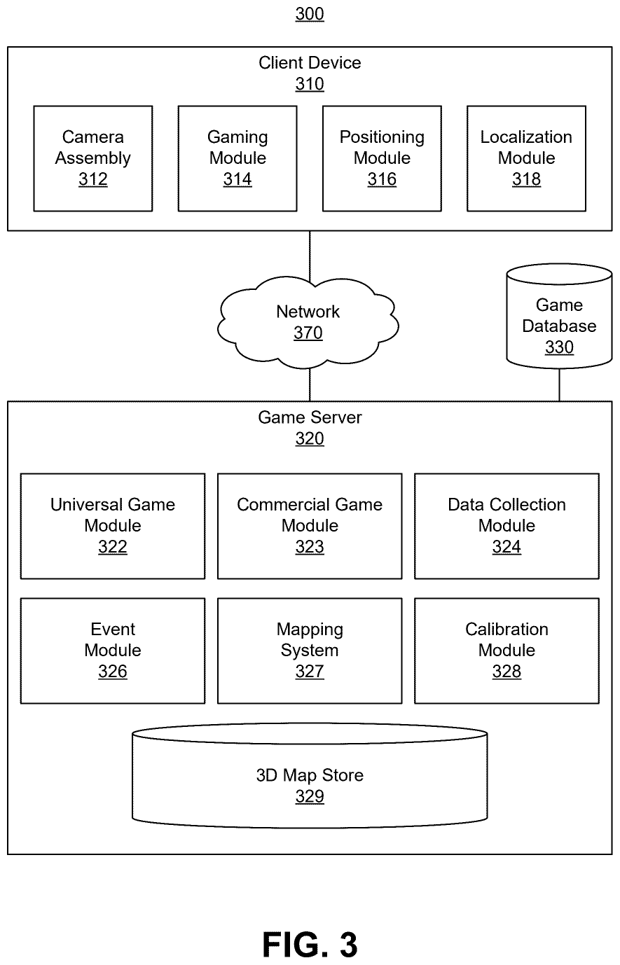

FIG. 3 illustrates one or more embodiments of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370.

Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one or more embodiments, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one or more embodiments, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one or more embodiments, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. In some embodiments, the localization module 318 leverages an ensemble of image-based localization models that are laterally calibrated. In such embodiments, the localization module 318 may input image data into the ensemble of localization models to output poses for the image data. Based on the pose, the client device 310 may generate content for presentation to the user. Alternatively, in some embodiments, the localization module 318 may determine a location or pose of the client device 310 without reference to a coarse location (such as one provided by a GPS system), such as by determining the relative location of the client device 310 to another device.

In one or more embodiments, each localization model is configured to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly. In one or more embodiments, one or more of the localization models may be machine-learning models, trained with training datasets.

In some embodiments, the ensemble of localization models may be stored locally on the client device 310. In such embodiments, the client device 310 may obtain a 3D map (e.g., cached on the client device 310, or retrieved over the network 370 from the game server 320) to perform the image-based localization with the localization models. The client device 310 may deploy the ensemble of localization models. In other embodiments, the ensemble of localization models may be stored remotely from the client device 310. In such embodiments, the localization module 318 may provide the image data to the game server 320 for execution of the ensemble of localization models. The output of the ensemble of models is transmitted over the network 370 from the game server 320 back to the client device 310.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one or more embodiments, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, a calibration module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world.

For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one or more embodiments, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The calibration module 328 calibrates the ensemble of localization models used to perform image-based localization, e.g., by the localization module 318. Each localization model may be distinctly trained or configured. For example, a first localization model is trained as machine-learning model according to one architecture, whereas a second localization model is trained with another architecture. In another example, one localization model is trained with monocular image data, whereas another localization model is trained with stereoscopic image data. In a third example, one localization model is configured to input a single frame and to output pose of the single frame, whereas a second localization model is configured to input a series of frames and to output pose of the final target frame. In still another example, one model may be trained in a supervised learning manner, whereas another model may be trained via unsupervised training data. In yet another example, one localization model is configured to input exclusively image data, whereas another localization model is configured to input other contextual data (e.g., inertial data, global positioning system data, wireless signal connections, etc.) in conjunction with the image data. In other examples, the localization models may apply different filters and/or checks to clamp, reweight, or otherwise manipulate confidences in complex fashions. In a first example implementation, a localization model matches sparse key points in the frame to determine the pose of the frame. In a second example implementation, a localization model performs dense regression of correspondences (i.e., features) across frames. Each localization model may be further configured to output a model-specific confidence associated with the output, wherein the confidence indicates a degree of certainty in the pose estimation.

To calibrate the ensemble of localization models, the calibration module 328 leverages a dataset inclusive of image data and associated ground truth pose. For each localization model, the calibration module 328 inputs frames of the image data into the localization model to output predicted poses for the frames and corresponding model-specific confidences. The calibration module 328 may determine an error for each prediction by comparing against the ground truth pose. The calibration module 328 may plot the model's confidence against the error to determine a model-specific confidence curve. The calibration module 328 may determine a linearization transformation that transforms the confidence curve to a linear curve of confidence against error. In other embodiments, the calibration module 328 may leverage another type of transformation (e.g., that is used to determine model-specific transformations applied to each model-specific confidence curve). The transformations conform the disparate model-specific confidence curves into a standardized curve, providing comparability of confidence scores across the linearization models.

When deploying the ensemble of localization models, an input frame is input into each localization model to output a predicted pose and a model-specific confidence score. The model-specific confidence score is input into each model-specific transformation to yield a calibrated confidence score. Based on the calibrated confidences, a final pose may be determined. In some embodiments, the final pose may be the predicted pose associated with the highest calibrated confidence. In other embodiments, the final pose may be an aggregation of one or more of the predictions, which may be weighted based on the corresponding calibrated confidences. In some embodiments, a smoothing algorithm may be implemented across successive frames to mitigate any artifacts from leveraging the ensemble of localization models.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Image-Based Localization With Ensemble of Localization Models

In one or more embodiments, one or more of the computing devices perform image-based localization with an ensemble of localization models to predict pose from image data. The localization models may be distinctly trained or configured, such that each localization model may output differing predictions and corresponding confidence scores. In particular, each localization model may output confidence scores in different confidence score ranges, or may output confidence scores with a different distribution compared to another model operating in the same range of confidence scores. For example, a first model may output confidence scores in the numerical range of [0, 1], whereas a second model may output confidence scores in the numerical range of [400, 800]. If the first model output a confidence score of 0.9 and the second model output a confidence score of 650, there's no manner of directly comparing the two confidence scores. Assuming, for the sake of example, a third model outputs confidence scores in the numerical range of [0, 1] (i.e., the same numerical range as the first model), but perhaps the confidence score of 0.9 represents high confidence in the first model, while representing poor confidence in the third model. The incomparability of confidence scores by disparate localization models creates a technical barrier in coordinating an ensemble of localization models.

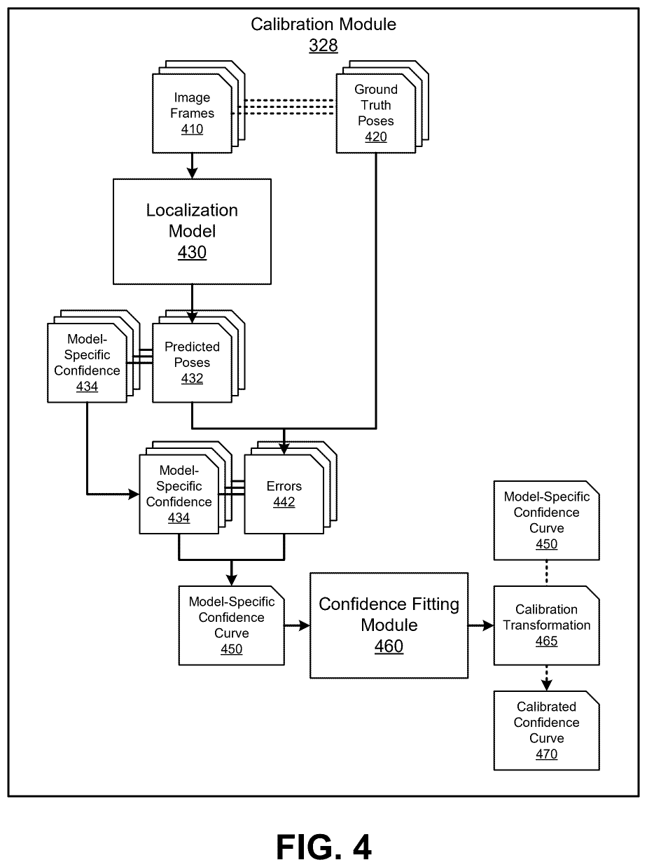

FIG. 4 is a flowchart illustrating localization model calibration, according to one or more embodiments. FIG. 4 is described as being performed by the calibration module 328 of the game server 320. In other embodiments, another computing system may perform some or all of the localization model calibration. FIG. 4 is also described in the context of a single localization model, the calibration module 328 repeats the calibration process for each localization model included in an ensemble of localization models.

The calibration module 328 receives a calibration data set including image frames 410 and ground truth poses 420. Each image frame 410 may have a matching ground truth pose 420. The image data may include monocular frames or stereoscopic frames. Each frame may depict a real-world environment, e.g., captured by a camera assembly of a mobile device. In other embodiments, the image data may include virtually rendered frames, e.g., from a graphics engine. A ground truth pose 420 describes the pose of the camera assembly when capturing an image frame 410. In some embodiments, the ground truth pose 420 is captured by a position sensor coupled to the camera assembly, e.g., an inertial measurement unit, an accelerometer, etc.

The calibration module 328 inputs the image frames 410 into the localization model 430 to output predicted poses 432 for the image frames 410 and associated model-specific confidences 434. In some embodiments, the localization model is configured to input one image frame (i.e., a “target frame”) to output a predicted pose for the image frame. Alternatively, the localization model may be configured to input a series of image frames, with one of the image frames in the series (e.g., the final image frame) as the target frame, and to output a predicted pose for the target frame. The localization model may be configured to input additional data in conjunction with the image data.

A pose includes both a position of the camera assembly and an orientation of the camera assembly. The pose may be absolute, i.e., measured against an objective coordinate system, or relative, i.e., measured in relation to other poses in a series of image frames 410. In one or more embodiments, the ground truth poses 420 are absolute, measured against an objective coordinate system. In embodiments where the localization model may be configured to output relative poses, i.e., between image frames, then the calibration module 328 may leverage a transformation to translate the relative poses to absolute poses. The calibration module 328 may determine the transformation by aligning ground truth poses captured by a position sensor coupled to the camera assembly (i.e., which are in arbitrary device coordinates) to multiple estimates for all frames of the tracking sequence of a localization model. As the localization model and the position sensor may be prone to errors, the calibration module 328 may determine the transformation using random sample consensus (RANSAC) to achieve a robust transformation. As noted above, each localization model may output model-specific confidences 434, i.e., in a model-specific numerical range, or in a model-specific gradation.

The calibration module 328 determines errors 442 based on a comparison of the predicted poses 432 and the ground truth poses 420. The pairwise error between a predicted pose 432 for an image frame 410 and the ground truth pose 420 for the image frame 410 may be based on the difference in positions of the two poses and the orientation of the two poses. The error may be a scalar value. With the model-specific confidences 434 and the errors 442, the calibration module 328 may plot confidences 434 against errors 442 to determine a model-specific confidence curve 450. In one or more embodiments, the calibration module 328 may plot the model-specific confidences and the associated errors. The calibration module 328 may fit a curve to the plotted data points.

In other embodiments, the calibration module 328 may iterate stepwise through different confidence thresholds to identify a percentage of predicted poses at or above the confidence threshold that has an error below an error tolerance. For example, with a model outputting confidence in the numerical range of [0, 1], the calibration module 328 may start at 0.05 confidence to identify what percentage of data points (having a confidence above the 0.05 confidence threshold) have error below the error tolerance (accuracy of the estimates), e.g., 20% of data points have error below the error tolerance (perhaps a low accuracy, in light of the very low confidence threshold). The calibration module 328 steps up to 0.10 confidence to identify what percentage of data points at or above the confidence threshold have error below the same error tolerance, e.g., 25% of data points (an improved accuracy compared to the 0.05 confidence threshold). The calibration module 328 continues stepping up the confidence threshold up to the top of the numerical range, identifying an accuracy of the estimates above that confidence threshold at each confidence step. For example, at the top of the range, the accuracy for data points above the confidence threshold of 0.95 might also be very high, e.g., 98% accuracy. The calibration module 328 can plot the confidence threshold steps against the identified percentages from the calibration data set. In one or more embodiments, the calibration module 328 may analyze the model-specific confidence curve 450 to identify weaknesses in the localization model. For example, the calibration module 328 may identify instances where the localization model consistently outputs high confidence estimates that are, in actuality, poor in accuracy. The calibration module 328 may flag such incidences for tuning of the localization model.

A confidence fitting module 460 determines a calibration transformation 465 that conforms the model-specific confidence curve 450 to a calibrated confidence curve 470. The calibrated confidence curve 470 may be a linear curve, e.g., 5% confidence translates to 5% likelihood of the predicted pose being accurate (i.e., below the error tolerance), 80% confidence translates to 80% likelihood of the predicted pose being accurate (i.e., below the error tolerance). The calibration transformation is a linear mapping of model-specific confidences in the numerical range output by the model to calibrated confidences in a standard numerical range. The calibration module 328 performs the calibration for each localization model 430, yielding a model-specific calibration transformation 465. Each calibration transformation 465 conforms the model-specific confidence curves 450 to the same calibrated confidence curve 470. The calibrated confidence curve 470 may be linear.

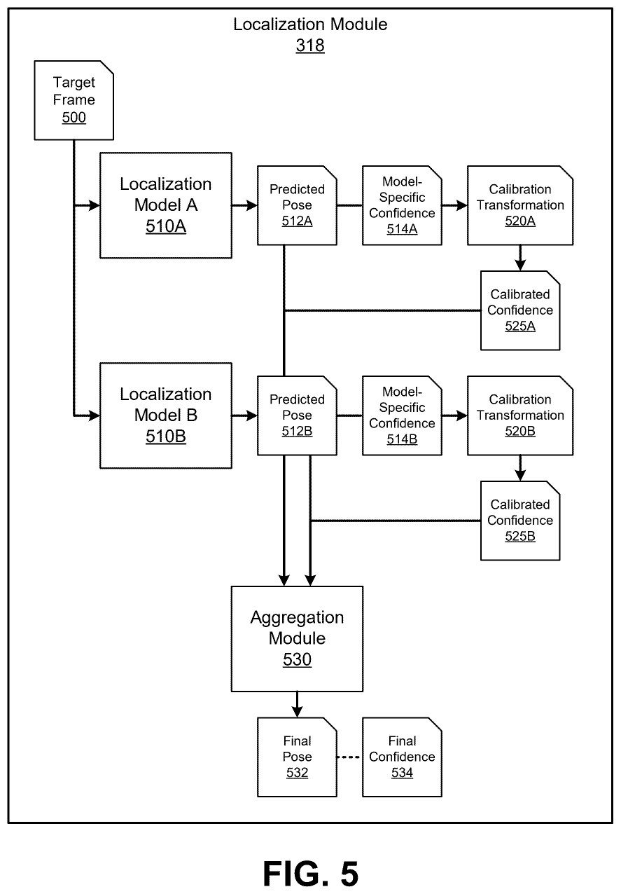

FIG. 5 is a flowchart illustrating deploying of an ensemble of calibrated localization models 510, according to one or more embodiments. The illustration shows two localization models 510, including Model A 510A and Model B 510B. In other embodiments, there may be any number of localization models. FIG. 5 is described as being performed by the localization module 318 of the client device 310. In other embodiments, another computing system may perform some or all of the image-based localization with the ensemble of calibrated localization models 510.

The localization module 318 inputs a target frame 500 (e.g., captured by a camera assembly) into each localization model 510. For example, Model A 510A inputs the target frame 500 and outputs a predicted pose 512A and a model-specific confidence 514A, and Model B 510B inputs the target frame 500 and outputs a predicted pose 512B and a model-specific confidence 514B. For Model A 510A, the model-specific confidence 514A is transformed according to the calibration transformation 520A (e.g., as determined by the calibration module 328 for Model A 510A) to yield a calibrated confidence 525A for the predicted pose 512A. Similar workflow for Model B 510B, the model-specific confidence 514B is transformed according to the calibration transformation 520B (e.g., as determined by the calibration module 328 for Model B 510B) to yield a calibrated confidence 525B for the predicted pose 512B.

An aggregation module 530 inputs the predicted poses 512 and the calibrated confidences 525 to determine a final pose 532 and final confidence 534. In some embodiments, the aggregation module 530 identifies the predicted pose 512 with the highest calibrated confidence 525 as the final pose 532. For example, if calibrated confidence 525A is higher than the calibrated confidence 525B, then the aggregation module 530 would, in such embodiments, select the predicted pose 512A from Model A 510A as the final pose 532 and its calibrated confidence 525A as the final confidence 534. In other embodiments, the aggregation module 530 may determine the final pose 532 as an aggregation of the predicted poses 512. The aggregation module 530 may determine the final pose 532 as a weighted average of the predicted poses 512, weighted according to calibrated confidences 525 (with a similar aggregation for the final confidence 534). For example, the aggregation module 530 may weight contribution of the predicted pose 512A to the final pose 532 highest based on the calibrated confidence 525A being the highest.

In some embodiments, the aggregation module 530 may leverage prior final poses output for past frames in the sequence of frames of the image data to inform aggregation of the final pose 532. The aggregation module 530 may apply a smoothing algorithm informed by the prior poses to limit noisy pose changes from frame to frame. The smoothing algorithm may factor in the prior poses with a temporal attenuation factor, i.e., the nearest-in-time pose influences the smoothing more than the furthest-in-time pose. For example, if the aggregation module 530 frequently switches between selection of predicted poses from different localization models, the final poses may jump back and forth between the modality of each localization model. The smoothing algorithm can smooth out any potential noisy pose changes from different model modalities. The advantage of leveraging an ensemble of localization models lies in the ability to exploit the strongest localization model per context. The calibration equips the ensemble to compare the localization models'outputs, and can be used to aggregate the outputs into one final pose.

### Example Methods

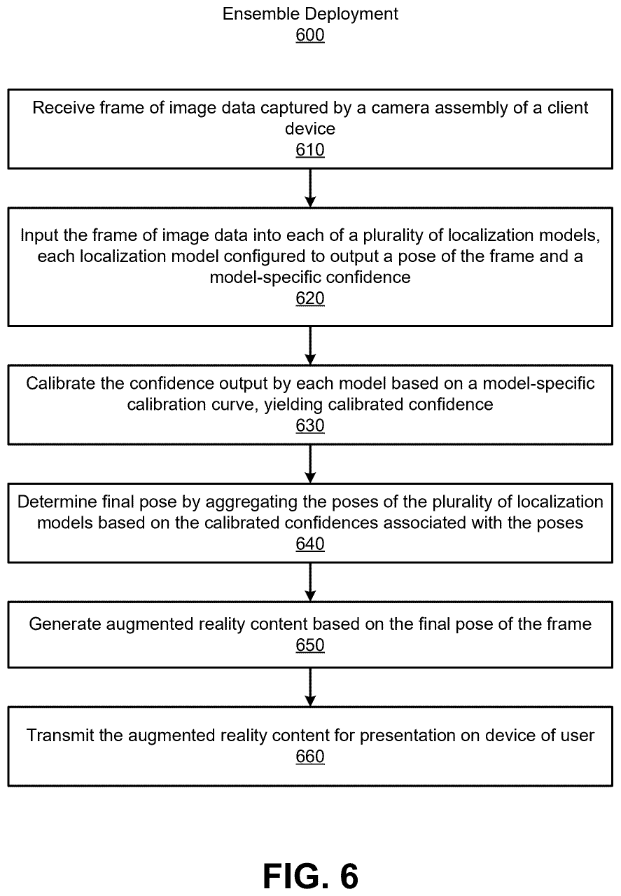

FIG. 6 is a method flowchart describing deployment 600 of an ensemble of calibrated localization models, according to one or more embodiments. The deployment 600 of the ensemble is described as being performed by a system, which may be the client device 310 or the game server 320. In other embodiments, the deployment 600 of the ensemble is performed by one or more devices. In other embodiments, the deployment 600 may include additional, fewer, or different steps than those listed.

The system receives 610 a target frame from image data captured by a camera assembly of a client device. The client device may be used by a user in an augmented reality context. In such context, the system may localize the image data with the objective of augmenting the image data with virtual content.

For each localization model of an ensemble of localization models disparately trained, the system inputs 620 the target frame into the localization model trained to output a pose of the target frame and a model-specific confidence for the pose. In one or more embodiments, a first localization model of the ensemble of localization models is trained as a machine-learning model with a first architecture, and a second localization model of the ensemble of localization models is trained as a machine-learning model with a second architecture that is different from the first architecture. In one or more embodiments, a first localization model of the ensemble of localization models is trained as a machine-learning model in a supervised manner, and a second localization model of the ensemble of localization models is trained as a machine-learning model in an unsupervised manner. In one or more embodiments, wherein a first localization model of the ensemble of localization models is trained with monocular image data, and a second localization model of the ensemble of localization models is trained with stereoscopic image data. In one or more embodiments, a first localization model of the ensemble of localization models is configured to input a series of frames including the target frame, and a second localization model of the ensemble of localization models is configured to input the target frame. In one or more embodiments, the localization model compares the target frame to reference image data or a spatial model of a real-world environment in determining the pose.

The system calibrates 630 each model-specific confidence by applying a calibration transformation specific to the localization model to the model-specific confidence to yield a calibrated confidence for the pose output by the localization model. In one or more embodiments, a first localization model of the ensemble of localization models is configured to output confidence in a first numerical range, wherein a second localization model of the ensemble of localization models is configured to output confidence in a second numerical range that is different from the first numerical range. In such embodiments, a first calibration transformation for the first localization model is a linear mapping of the first numerical range to a standard numerical range, wherein a second calibration transformation for the second localization model is a linear mapping of the second numerical range to the standard numerical range. In one or more embodiments, a first localization model of the ensemble of localization models is configured to output confidence in a numerical range according to a first model-specific curve, wherein a second localization model of the ensemble of localization models is configured to output confidence in the numerical range according to a second model-specific curve that is different from the first model-specific curve. In such embodiments, a first calibration transformation for the first localization model conforms the first model-specific curve to a linear curve, wherein a second calibration transformation for the second localization model conforms the first model-specific curve to the linear curve.

The system determines 640 a final pose for the target frame by aggregating the poses output by the localization models based on the calibrated confidences for the poses. The system can determine the final pose by ranking the poses by the calibrated confidences and selecting the pose at a top of the ranking as the final pose. The system can, in other embodiments, determine the final pose as a weighted average of one or more poses weighted based on the calibrated confidences. In some embodiments, the system can apply a smoothing based on prior poses predicted for prior frames of the image data.

The system can generate 650 augmented reality content by augmenting the target frame of the image data with virtual elements based on the final pose for the target frame. Generating the augmented reality content may entail obtaining the virtual elements from a database, wherein each virtual element includes placement criteria guiding placement of the virtual element in the augmented reality content. The system can determine rendering characteristics for each virtual element based on the final pose and the placement criteria, and render the virtual elements according to the rendering characteristics. For example, a virtual element may be exclusively accessible at a particular position in the parallel reality game. If the player's device is not at the particular position, the system does not render that virtual element. Once the player's device is at the particular position, the system can render that virtual element. In other embodiments, the virtual element may be animated, with the appearance of interacting with real-world elements. The animation may be informed by the pose of the image data.

The system transmits 660 the augmented reality content to the client device for presentation to a user. The client device may present the augmented reality content via an electronic display. In some embodiments, the client device may be associated with a headset including one or more lens elements for presenting the augmented reality content.

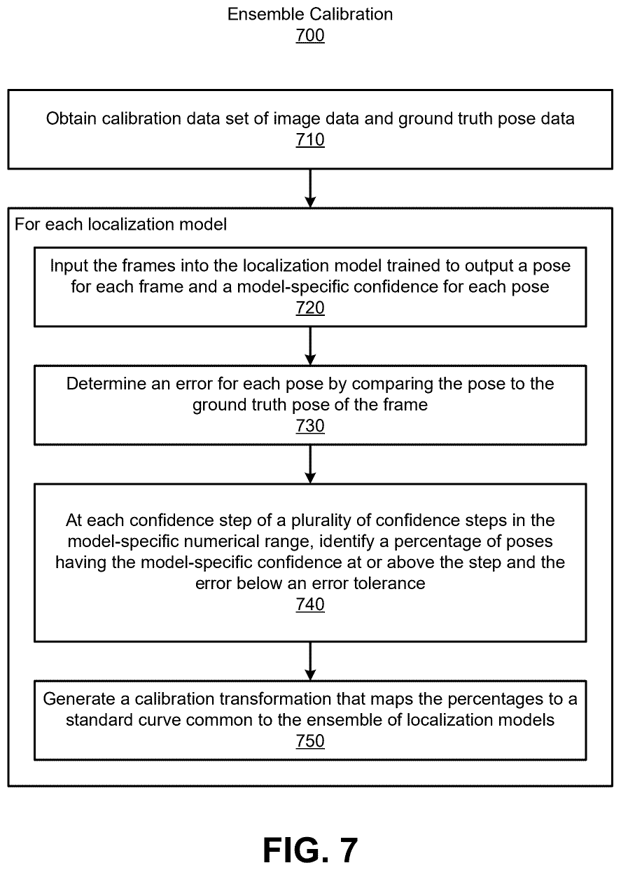

FIG. 7 is a method flowchart describing calibration 700 of an ensemble of calibrated localization models, according to one or more embodiments. The calibration 700 of the ensemble is described as being performed by a system, which may be the client device 310 or the game server 320. In other embodiments, the calibration 700 of the ensemble is performed by one or more devices. In other embodiments, the calibration 700 may include additional, fewer, or different steps than those listed.

The system obtains 710 a calibration data set of image data and ground truth pose data. The image data includes a plurality of frames captured by one or more camera assemblies, whereas the ground truth pose data includes a plurality of ground truth poses captured by one or more inertial measurement units (or more generally position sensor(s))coupled to the one or more camera assemblies.

To calibrate each localization model, the system inputs 720 the frames into the localization model trained to output a pose for each frame and a model-specific confidence for each pose. Each localization model may output confidences in a model-specific numerical range or according to a model-specific curve. The confidence outputs between different localization models may not be directly comparable.

In calibrating the localization model, the system determines 730 an error for each pose by comparing the pose to the ground truth pose of the frame. In some embodiments, the error may include a positional error and an orientational error. The positional error is a difference in a position of the predicted pose and a position of the ground truth pose. The orientational error is a difference in an orientation of the predicted pose and an orientation of the ground truth pose.

In calibrating the localization model, the system, at each confidence step of a plurality of confidence steps in the model-specific numerical range, identifies 740 a percentage of poses having the model-specific confidence at or above the step and the error below an error tolerance. The plurality of confidence steps discretizes the model-specific numerical range. The error tolerance may, similarly, have a positional error tolerance and an orientational error tolerance.

In calibrating the localization model, the system generates 750 a calibration transformation that maps the percentages to a standard curve common to the ensemble of localization models. In one or more embodiments, the standard curve linearly correlates confidence to likelihood of predicted pose being below the error tolerance. In one or more embodiments, the system can generate a lookup table that maps each confidence step of the plurality of confidence steps to a calibrated confidence on the standard curve. In other embodiments, the system fits a model-specific confidence curve to the percentages at the plurality of confidence steps in the model-specific numerical range. The system then generates the calibration transformation based on the model-specific confidence curve. The calibration transformation may, in such embodiments, be a function that conforms the model-specific confidence curve to the standard curve.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one or more embodiments” or “an embodiment” means that a particular element, feature, structure, or characteristic described in connection with the embodiment is included in at least one or more embodiments. The appearances of the phrase “in one or more embodiments” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving a target frame from image data captured by a camera assembly of a client device;
for each localization model of an ensemble of localization models that are disparately trained, inputting the target frame into the localization model trained to obtain a pose of the target frame and a model-specific confidence for the pose;
calibrating each model-specific confidence by applying a calibration transformation specific to the localization model to the model-specific confidence to yield a calibrated confidence for the pose output by the localization model;
determining a final pose for the target frame by aggregating the poses output by the localization models based on the calibrated confidences for the poses; and
providing the final pose for provision of functionality by the client device.

2. The computer-implemented method of claim 1, further comprising:
generating augmented reality content by augmenting the target frame of the image data with virtual elements based on the final pose for the target frame; and
transmitting the augmented reality content to the client device for presentation to a user.

3. The computer-implemented method of claim 2, wherein generating the augmented reality content comprises:
obtaining the virtual elements from a database, wherein each virtual element includes placement criteria guiding placement of the virtual element in the augmented reality content;
determining rendering characteristics for each virtual element based on the final pose and the placement criteria; and
rendering the virtual elements according to the rendering characteristics.

4. The computer-implemented method of claim 1, wherein a first localization model of the ensemble of localization models is trained as a machine-learning model with a first architecture, and a second localization model of the ensemble of localization models is trained as a machine-learning model with a second architecture that is different from the first architecture.

5. The computer-implemented method of claim 1, wherein a first localization model of the ensemble of localization models is trained as a machine-learning model in a supervised manner, and a second localization model of the ensemble of localization models is trained as a machine-learning model in an unsupervised manner.

6. The computer-implemented method of claim 1, wherein a first localization model and a second localization model of the ensemble of localization models are configured to input a series of frames including the target frame, wherein the first localization model is trained as a machine-learning model configured to input the series of frames including the target frame and to output the pose based on the series of frames, and the second localization model is configured to match key points present in the target frame to key points in other frames in the series of frames to output the pose.

7. The computer-implemented method of claim 1, wherein a first localization model of the ensemble of localization models is trained with monocular image data, and a second localization model of the ensemble of localization models is trained with stereoscopic image data.

8. The computer-implemented method of claim 1, wherein a first localization model of the ensemble of localization models is configured to input a series of frames including the target frame, and a second localization model of the ensemble of localization models is configured to input the target frame.

9. The computer-implemented method of claim 1, wherein a first localization model of the ensemble of localization models is configured to output confidence in a first numerical range, wherein a second localization model of the ensemble of localization models is configured to output confidence in a second numerical range that is different from the first numerical range, wherein a first calibration transformation for the first localization model is a linear mapping of the first numerical range to a standard numerical range, wherein a second calibration transformation for the second localization model is a linear mapping of the second numerical range to the standard numerical range.

10. The computer-implemented method of claim 1, wherein a first localization model of the ensemble of localization models is configured to output confidence in a numerical range according to a first model-specific curve, wherein a second localization model of the ensemble of localization models is configured to output confidence in the numerical range according to a second model-specific curve that is different from the first model-specific curve, wherein a first calibration transformation for the first localization model conforms the first model-specific curve to a linear curve, wherein a second calibration transformation for the second localization model conforms the second model-specific curve to the linear curve.

11. The computer-implemented method of claim 1, wherein determining the final pose for the target frame by aggregating the poses output by the localization models based on the calibrated confidences for the poses comprises:
ranking the poses by the calibrated confidences; and
selecting the pose at a top of the ranking as the final pose.

12. The computer-implemented method of claim 1, wherein determining the final pose for the target frame by aggregating the poses output by the localization models based on the calibrated confidences for the poses comprises:
determining the final pose as a weighted average of one or more poses weighted based on the calibrated confidences.

13. The computer-implemented method of claim 1, wherein determining the final pose for the target frame comprises applying a smoothing based on prior poses predicted for prior frames of the image data.

14. A computer-implemented method comprising:
obtaining a calibration data set including a plurality of frames captured by one or more camera assemblies and a plurality of ground truth poses captured by one or more inertial measurement units coupled to the one or more camera assemblies;
for each localization model of an ensemble of localization models disparately trained:
inputting the frames into the localization model trained to output a pose for each frame and a model-specific confidence for each pose in a model-specific numerical range;
determining an error for each pose by comparing the pose to the ground truth pose of the frame;
at each confidence step of a plurality of confidence steps in the model-specific numerical range, identifying a percentage of poses having the model-specific confidence at or above the step and the error below an error tolerance; and
generating a calibration transformation that maps the percentages to a standard curve common to the ensemble of localization models.

15. The computer-implemented method of claim 14, wherein the plurality of confidence steps discretizes the model-specific numerical range.

16. The computer-implemented method of claim 14, wherein determining the error for each pose by comparing the pose to the ground truth pose of the frame includes:
determining a positional error in a position of the pose and a position of the ground truth pose; and
determining an orientational error in an orientation of the pose and an orientation of the ground truth pose.

17. The computer-implemented method of claim 16, wherein, at each confidence step of a plurality of confidence steps in the model-specific numerical range, identifying the percentage of poses having the model-specific confidence at or above the step and the error below the error tolerance comprises identifying the percentage of poses having the positional difference below a positional error tolerance and the orientational error below an orientational error tolerance.

18. The computer-implemented method of claim 14, wherein the standard curve linearly correlates confidence to likelihood of predicted pose being below the error tolerance.

19. The computer-implemented method of claim 14, wherein generating the calibration transformation comprises:
generating a lookup table that maps each confidence step of the plurality of confidence steps to a calibrated confidence on the standard curve.

20. The computer-implemented method of claim 14, further comprising:
for each localization model of the ensemble of localization models, fitting a model-specific confidence curve based on the percentages at the plurality of confidence steps in the model-specific numerical range, wherein the calibration transformation is based on the model-specific confidence curve.

21. The computer-implemented method of claim 20, wherein, for each localization model of the ensemble of localization models, generating the calibration transformation comprises:
determining a function that conforms the model-specific confidence curve to the standard curve.
